(19) United States
(12) Patent Application Publication
(10) Pub. No.: US 2016/0084158 A1
(43) Pub. Date: Mar. 24, 2016

(54) ROTARY PISTON ENGINE MOUNTED ON VEHICLE

(71) Applicant: Mazda Motor Corporation, Hiroshima (JP)

(72) Inventors: Ritsuharu Shimizu, Hiroshima-shi (JP); Masanao Yamada, Hiroshima-shi (JP); Takanori Sakai, Hiroshima-shi (JP); Jimii Uchiyama, Kure-shi (JP)

(21) Appl. No.: 14/825,035

(22) Filed: Aug. 12, 2015

(30) Foreign Application Priority Data
Sep. 22, 2014 (JP) 2014-192220

(51) Int. Cl. F02B 53/14; F02B 55/08; B60K 13/04; F02B 37/00; B60K 5/00; B60K 13/02; F02B 55/02; F02B 55/16

(52) U.S. Cl. CPC F02B 53/14; F02B 55/02; F02B 55/08; F02B 55/16; F02B 37/00; B60K 5/00; B60K 13/02; B60K 13/04

(57) ABSTRACT

A rotary piston engine mounted on a vehicle is provided. The engine includes a rotary piston engine body mounted on the vehicle in an orientation where an output shaft of the rotary piston engine body extends substantially horizontally, an intake passage connected with an intake port formed in the rotary piston engine body, and an exhaust passage connected with an exhaust port formed in the rotary piston engine body. When the rotary piston engine is seen along the output shaft, the intake port is formed in a lower part of the rotary piston engine body and the exhaust port is formed in an upper part of the rotary piston engine body. The intake passage is disposed on one side of the rotary piston engine body and the exhaust passage is disposed above the rotary piston engine body.

### BACKGROUND

The present invention relates to a rotary piston engine mounted on a vehicle.

JP2009-085116A discloses a rotary piston engine mounted on a vehicle. This rotary piston engine is mounted on a vehicle such that its output shaft is oriented horizontally. Moreover, intake ports and exhaust ports are formed in a side housing and an intermediate housing forming a rotor accommodation chamber inside the rotary piston engine. When the rotary piston engine is seen along the output shaft from one side thereof, the rotor accommodation chamber has a substantially ellipse shape like a cocoon, the intake port is located at a position on one side of the rotor accommodation chamber in a short axis of the rotor accommodation chamber and on an upper side of the rotor accommodation chamber with respect to the short axis of the rotor accommodation chamber, and the exhaust port is located at a position on the side of the rotor accommodation chamber in the short axis and on a lower side of the rotor accommodation chamber with respect to the short axis.

Further, an intake passage (including an intake manifold) connected with the intake ports extends upward of the rotary piston engine from a connecting position which is in an upper part of the rotary piston engine on the side of the rotor accommodation chamber in the short axis. A throttle body is provided to intervene in the intake passage, above the rotary piston engine. Meanwhile, an exhaust passage (including an exhaust manifold) connected with the exhaust ports extends rearward of the vehicle from a connecting position which is in a lower part of the rotary piston engine on the side of the rotor accommodation chamber in the short axis.

Recently, an engine which can be efficiently mounted even in a small engine room has been desired. Further, improved performance of rotary piston engines is also desired.

### SUMMARY

The present invention is made in view of the above situations and aims to improve performance of a rotary piston engine while improving mountability thereof.

According to one aspect of the present invention, a rotary piston engine mounted on a vehicle is provided. The rotary piston engine includes a rotary piston engine body mounted on the vehicle in an orientation where an output shaft of the rotary piston engine extends substantially horizontally, an intake passage connected with an intake port formed in the rotary piston engine body, and an exhaust passage connected with an exhaust port formed in the rotary piston engine body.

When the rotary piston engine is seen along the output shaft, the intake port is formed in a lower part of the rotary piston engine body and the exhaust port is formed in an upper part of the rotary piston engine body. The intake passage is disposed on one side of the rotary piston engine body and the exhaust passage is disposed above the rotary piston engine body.

As described in JP2009-085116A, conventionally, in a case where a rotary piston engine is mounted on a vehicle in an orientation where an output shaft of the rotary piston engine extends horizontally, when the rotary piston engine is seen along the output shaft, an intake port is formed in an upper part of the rotary piston engine and an exhaust port is formed in a lower part of the rotary piston engine.

On the other hand, with the above configuration according to the present invention, the intake port is formed in the lower part of the rotary piston engine body and the exhaust port is formed in the upper part of the rotary piston engine body. That is, in the rotary piston engine with this configuration, the rotary piston engine body is mounted on the vehicle in a state corresponding to the conventional rotary piston engine rotated by 180 degrees centering on the output shaft so that the disposition of the intake port and the exhaust port becomes opposite in the up-and-down direction from the conventional rotary piston engine.

In the conventional rotary piston engine, since the intake port is formed in the upper part, the intake passage disposed in an upper part inside an engine room has a comparatively short length and is connected with the intake port.

On the other hand, in the rotary piston engine with the above configuration according to the present invention, the intake port is formed in the lower part, and accordingly, the intake passage is disposed to extend downward from above at a position on one side of the rotary piston engine body and then be connected with the intake port. Note that the “intake passage” referred to here includes an intake manifold having a common passage and independent passages. Therefore, a length of the intake passage becomes longer than that of the conventional configuration. Such a length, as a result, can be advantageous in obtaining a dynamic forced-induction effect caused by an inertia effect.

Moreover, in the rotary piston engine with the above configuration according to the present invention, the exhaust port is formed in the upper part and the exhaust passage is disposed above the rotary piston engine body. Note that the “exhaust passage” referred to here includes an exhaust manifold having independent passages and a manifold passage. A length of the exhaust passage becomes comparatively short, and thus, a passage resistance in the exhaust passage can be decreased.

Since the dynamic forced-induction effect can be obtained on the intake side and the passage resistance can be decreased on the exhaust side as above, the performance of the rotary piston engine can be improved. Moreover, the intake passage disposed near the engine body is not provided with any large-size devices. Therefore, the entire size of the rotary piston engine can be reduced even if the intake passage is disposed on one side of the rotary piston engine body. Thus, the mountability of the rotary piston engine in a small engine room can be improved.

The rotary piston engine body may include a triangle rotor which rotates in a planetary fashion, a rotor housing having a trochoid inner circumferential surface with which the rotor slidably contacts, and a side housing disposed on one side of the rotor housing and for defining, together with the rotor housing, a rotor accommodation chamber for accommodating the rotor therein. The exhaust port may include an opening formed in the side housing to open to the rotor accommodation chamber, and having a predetermined substantially elongated triangle shape of which one side corresponds to an edge of the opening designed based on a trail of an oil seal provided to the rotor, and a passage portion extending to curve continuously from the opening, extending inside the side housing toward an outer circumferential surface of the rotary piston engine body, and opening to the outer circumferential surface. The passage portion may extend toward a center of gravity of the predetermined substantially elongated triangle from the edge of the opening. Note that when the rotary piston engine has a plurality of rotors, the “side housing” referred to here includes an intermediate housing disposed between the plurality of rotors aligned in the output shaft direction.

The opening of the exhaust port of the rotary piston engine is opened or closed by the rotation of the triangle rotor, and thus, a shape thereof is generally defined as follows. That is, the edge of the opening has the substantially elongated triangle shape formed by three sides as a whole. One of the three sides located on the inner side of the rotor accommodation chamber is designed based on the trail of the oil seal provided to a side surface of the rotor. One of the two sides located on the outer side is designed based on a shape of a circumferential surface of the rotor at a position of starting to open the exhaust port and the other side is designed based on a shape of the circumferential surface of the rotor at a position of fully closing the exhaust port.

With this configuration, in the exhaust port including the opening and the passage portion, the passage portion is provided to extend from the edge of the opening (i.e., the side designed based on the trail of the oil seal) toward the center of gravity of the substantially elongated triangle shape. Thereby, turbulence of the exhaust gas flow can be reduced in a curving portion where the opening and the passage portion are continuous. As a result, the passage resistance of the exhaust port can be decreased and an exhaust performance can be improved.

Moreover, with the conventional configuration in which the exhaust ports are formed in the lower part of the rotary piston engine, a passage portion extends substantially horizontally so that it opens to an outer circumferential surface of the rotary piston engine. On the other hand, with the above configuration according to the present invention, as a result of providing the passage portion to extend from one side of the edge of the opening toward the center of gravity of the substantially elongated triangle shape, the passage portion extends obliquely upward from the opening located in the upper part of the rotary piston engine body and opens to the circumferential surface of the upper part of the rotary piston engine. Thus, the connectivity of the passage portion to the exhaust passage disposed above the rotary piston engine can be improved and the passage resistance on the exhaust side can be decreased even more, thereby further improving the exhaust performance.

An exhaust turbocharger may be disposed in the exhaust passage. The exhaust turbocharger may be located above the rotary piston engine body.

The exhaust turbocharger is preferably provided near the exhaust port in the exhaust passage in order to effectively obtain exhaust energy. Therefore, the exhaust turbocharger is formed near the rotary piston engine body.

Here, with the conventional configuration in which the exhaust port is formed in the lower part of the rotary piston engine, the exhaust turbocharger is disposed near the lower part of the rotary piston engine. With this configuration, the exhaust turbocharger may interfere with vehicle members including a cross member.

On the other hand, with the above configuration according to the present invention, as described above, the exhaust port is formed in the upper part of the rotary piston engine body and the exhaust passage and the exhaust turbocharger are disposed above the rotary piston engine body. Thus, interference between the exhaust turbocharger and the vehicle body members can surely be inhibited while the exhaust turbocharger is disposed near the rotary piston engine body. Moreover, since interference in the lower part of the rotary piston engine body can be inhibited, the mounting position of the rotary piston engine body to the vehicle can be lowered as much as possible. As a result, the space above the rotary piston engine can easily be secured and, for example, a large-sized exhaust turbocharger can be accommodated inside the engine room by being disposed above the rotary piston engine body.

### BRIEF DESCRIPTION OF THE DRAWINGS

FIG. 1 is a plan view illustrating a rotary piston engine mounted on a vehicle according to one embodiment of the present invention.

FIG. 2 is a side view illustrating the rotary piston engine mounted on the vehicle.

FIG. 3 is a rear view illustrating the rotary piston engine mounted on the vehicle.

FIG. 4 is a cross-sectional view illustrating an internal structure of the rotary piston engine.

FIG. 5 is a view illustrating a part near an opening of an exhaust port of the rotary piston engine in an enlarged manner.

FIG. 6 is a conceptual view illustrating a shape of the exhaust port.

FIG. 7 is a view illustrating a relationship between the shape of the exhaust port and a passage resistance.

### DETAILED DESCRIPTION OF EMBODIMENT

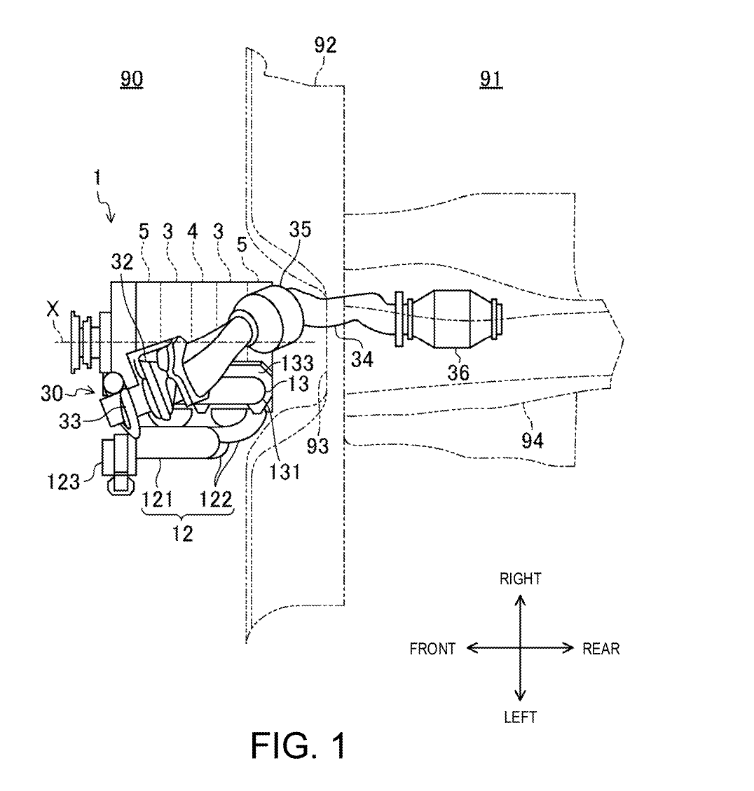

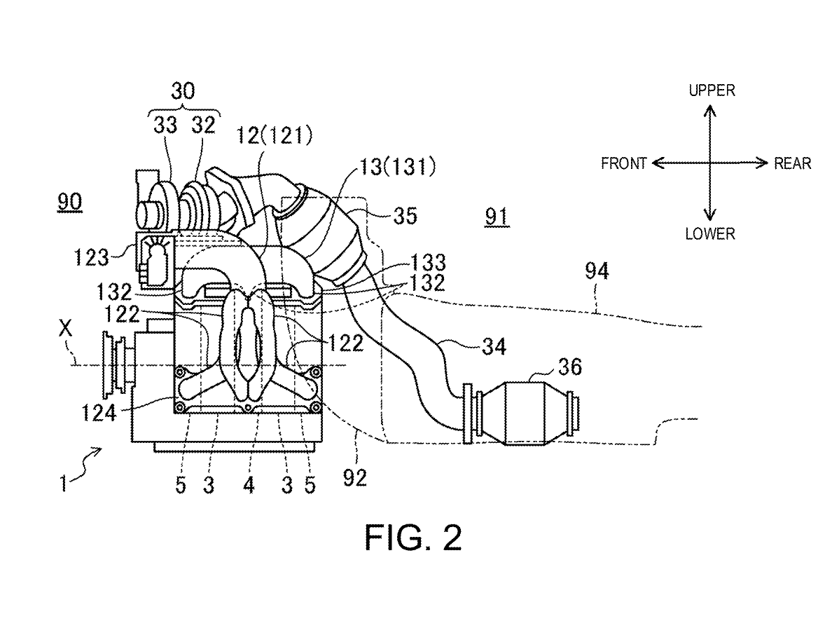

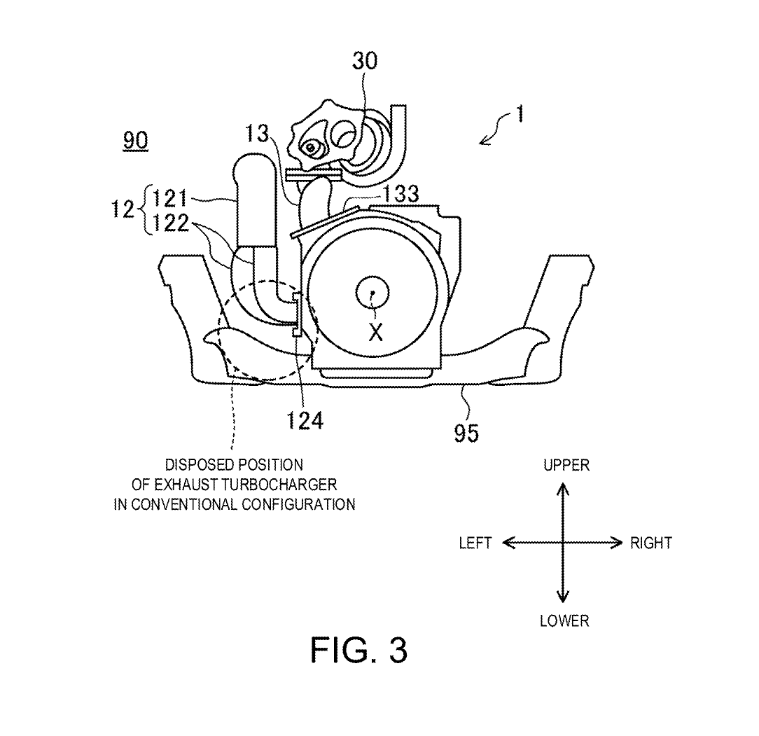

Hereinafter, a rotary piston engine according to one embodiment of the present invention is described with reference to the appended drawings. Note that the following description is illustrative. FIGS. 1 to 3 show a rotary piston engine 1 mounted on a vehicle (hereinafter, may simply be referred to as the engine 1) according to this embodiment. Specifically, FIG. 1 is a plan view of the engine 1 inside an engine room 90 seen from the top thereof, in which the left side of the sheet is a front side of the vehicle, the right side of the sheet is a rear side of the vehicle, the upper side of the sheet is a right side of the vehicle, and the lower side of the sheet is a left side of the vehicle. FIG. 2 is a side view of the engine 1 inside the engine room 90 seen from the left to right of the vehicle, in which the left side of the sheet is the front side of the vehicle, the right side of the sheet is the rear side of the vehicle, the upper side of the sheet is the upper side of the vehicle, and the lower side of the sheet is the lower side of the vehicle. FIG. 3 is a rear view of the engine 1 inside the engine room 90 seen from the rear to front of the vehicle, in which the left side of the sheet is the left side of the vehicle, the right side of the sheet is the right side of the vehicle, the upper side of the sheet is the upper side of the vehicle, and the lower side of the sheet is the lower side of the vehicle. Note that the vehicle right-and-left sides correspond to vehicle width directions.

The engine 1 is arranged inside the engine room 90 such that an output shaft X of the engine 1 is oriented in the vehicle front-and-rear directions. A dash panel 92 intervening between the engine room 90 and a cabin 91 is formed, in its center portion in the vehicle width directions, with a concave portion 93 which is formed to concave rearward from the front side of the vehicle and communicates with a floor tunnel 94. A rear end part of the engine 1 is located inside the concave portion 93. Thus, the engine 1 is disposed at the most rear position possible inside the engine room 90, and also a center of gravity of the engine 1 is at a lowest position possible. Such a design causes a weight distribution of the vehicle in the front-and-rear directions to be 50:50, which is advantageous in lowering the center of gravity of the vehicle.

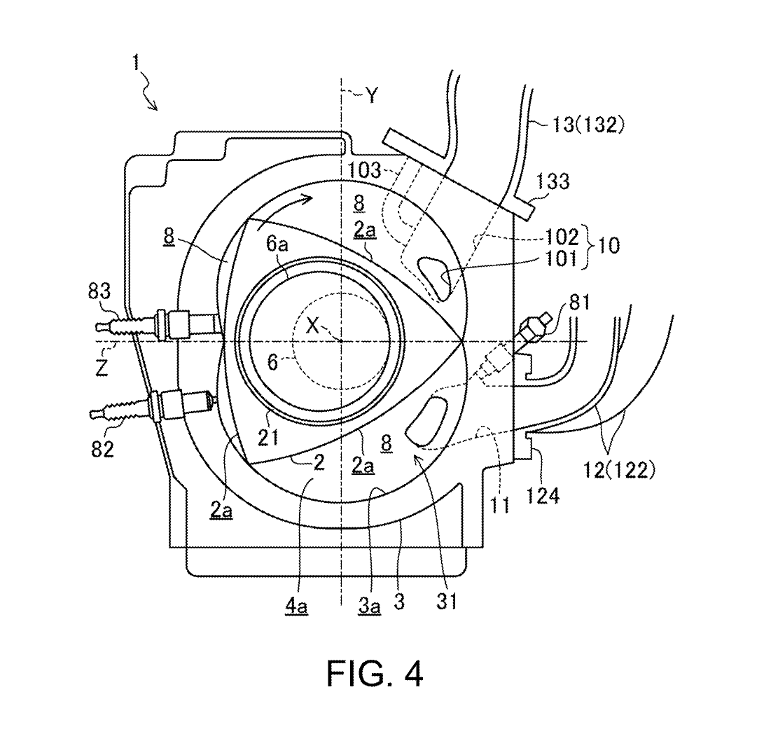

Although a detailed illustration is omitted, the engine 1 is a twin rotor type including two rotors 2 (see FIG. 4), and, as illustrated in FIGS. 1 and 2, is formed with two front and rear rotor housings 3 which sandwich an intermediate housing (i.e., side housing) 4 therebetween, and in this state, the rotor housings 3 are sandwiched by two side housings 5 to be integrated.

Further, two front and rear rotor accommodation chambers 31 having substantially ellipse shapes like cocoons when the rotary piston engine 1 is seen along the rotational shaft X from one side thereof are aligned in the vehicle front-and-rear directions. As illustrated in FIG. 4, the front and rear rotor accommodation chambers 31 are defined by trochoid inner circumferential surfaces 3a of the rotor housing 3, inner side surfaces (surfaces facing the vehicle front-and-rear directions) of the side housings 5 sandwiching the rotor housings 3, and inner side surfaces 4a (surfaces facing the vehicle front-and-rear directions) of the intermediate housing 4, respectively. Each of the trochoid inner circumferential surfaces 3a has a shape formed by a parallel trochoid curve. Each of the rotor accommodation chambers 31 accommodates one rotor 2. The rotor accommodation chambers 31 are arranged symmetrically with respect to the intermediate housing 4, and have the same configuration as each other except for the positions and phases of the rotors 2. Hereinafter, one of the rotor accommodation chambers 31 is described.

The rotor 2 is formed by a block body having a substantially triangle shape bulging in a center portion of each side thereof when seen along the rotational shaft X. The rotor 2 has, in its outer circumference, three substantially-oblong flank surfaces 2a between the vertex portions.

The rotor 2 has an apex seal (not illustrated) at each vertex portion, and the apex seals slidably contact with the trochoid inner circumferential surface 3a of the rotor housing 3. The trochoid inner circumferential surface 3a of the rotor housing 3, the inner side surface 4a of the intermediate housing 4, the inner side surface of the side housing 5, and the flank surfaces 2a of the rotor 2 define three operation chambers 8 inside the rotor accommodation chamber 31. Therefore, the engine 1 has a total of six operation chambers 8 (three of first to third operation chambers 8 in the front rotor accommodation chamber 31 and three of fourth to sixth operation chambers 8 in the rear rotor accommodation chamber 31).

A phase gear (not illustrated) is formed on an inner side (the side closer to the rotational shaft X) of the rotor 2. Specifically, an internal gear on the inner side of the rotor 2 (rotor gear) is meshed together with an external gear of an eccentric shaft 6 on the side housing 5 side (stationary gear), and the rotor 2 is supported to rotate in a planetary fashion with respect to the eccentric shaft 6 penetrating the intermediate housing 4 and the side housing 5 and configuring the output shaft X. Note that the reference numeral 21 indicates an oil seal provided to a side surface (surface facing the vehicle front-and-rear directions) of the rotor 2 and for preventing unnecessary lubrication oil from flowing into the operation chamber 8.

A rotation of the rotor 2 is defined by the meshing of the internal gear and the external gear. The rotor 2 rotates about an eccentric ring (eccentric axis) 6a of the eccentric shaft 6 while the three apex seals slide on the trochoid inner circumferential surface 3a of the rotor housing 3. The rotor 2 revolves in the same direction as the rotation (this revolution and rotation are simply referred to as the rotation in a broad sense) around the rotational shaft X. Further, while the rotor 2 fully rotates once (360 degrees), the three operation chambers 8 move in the circumferential direction; intake, compression, expansion (combustion), and exhaust strokes are performed in each operation chamber 8; and rotational force produced from the strokes is outputted from the eccentric shaft 6 via the rotor 2.

More specifically, in FIG. 4, the rotor 2 rotates in a clockwise fashion as indicated by the arrow and, when the rotor accommodation chamber 31 is divided into left and right sides by a long axis Y of the rotor accommodation chamber 31 passing through the rotational shaft X, the right side of the rotor accommodation chamber 31 substantially corresponds to a section where the intake and exhaust strokes are performed and the left side of the rotor accommodation chamber 31 substantially corresponds to a section where the compression and expansion strokes are performed.

On the other hand, in a conventional rotary piston engine, when the rotor accommodation chamber 31 is divided into left and right sides by the long axis Y of the rotor accommodation chamber 31 passing through the rotational shaft X, the left side of the rotor accommodation chamber 31 substantially corresponds to a section where the intake and exhaust strokes are performed and the right side of the rotor accommodation chamber 31 substantially corresponds to a section where the compression and expansion strokes are performed. In other words, the rotary piston engine of this embodiment is mounted on the vehicle in a state corresponding to the conventional rotary piston engine rotated by 180 degrees centering on the rotational shaft X.

When focusing on the operation chamber 8 at the lower right side of FIG. 4, this operation chamber 8 is on the intake stroke where mixture gas is formed by intake air and injected fuel (hereinafter, the operation chamber in such a state may be referred to as the intake operation chamber 8), and when the operation chamber 8 transits to the compression stroke as the rotor 2 rotates, the mixture gas is compressed therein (hereinafter, the operation chamber in such a state may be referred to as the compression operation chamber 8, which is not illustrated). Then, in the operation chamber 8 illustrated at the left side of FIG. 4, the mixture gas is ignited by ignition plugs 82 and 83 at predetermined timings, respectively, from the end of the compression stroke to the expansion stroke, and the combustion/expansion stroke is performed (hereinafter, the operation chamber in such a state may be referred to as the combustion/expansion operation chamber 8). Finally, when reaching the exhaust stroke as the operation chamber 8 illustrated at the upper right side of FIG. 4 (hereinafter, the operation chamber in such a state may be referred to as the exhaust operation chamber 8), exhaust gas is discharged from the exhaust port 10 to return to the intake stroke, and the respective strokes are repeated.

The intake operation chamber 8 communicates with an intake port 11. Specifically, the intake port 11 is formed lower than a short axis Z of the rotor accommodation chamber 31 passing through the rotational shaft X, in other words, in a lower part of the engine 1. More specifically, the intake port 11 opens, at a position relatively close to the short axis Z and the outer circumference of the rotor accommodation chamber 31, to the part of the inner side surface 4a of the intermediate housing 4 facing the intake operation chamber 8, and the intake port 11 extends substantially horizontally inside the intermediate housing 4 so as to open to a side surface of the engine 1. Moreover, although not illustrated, another intake port opens to the part of the inner surface of the side housing 5 facing the intake operation chamber 8, so as to oppose the intake port 11. The other intake port also extends substantially horizontally inside the side housing 5 so as to open to the side surface of the engine 1.

The exhaust operation chamber 8 communicates with an exhaust port 10. Specifically, the exhaust port 10 is formed higher than the short axis Z of the rotor accommodation chamber 31 passing through the rotational shaft X, in other words, in an upper part of the engine 1. More specifically, the exhaust port 10 opens at a position relatively close to the short axis Z and the outer circumference of the rotor accommodation chamber 31, to the part of the inner side surface 4a of the intermediate housing 4 facing the exhaust operation chamber 8, and the exhaust port 10 extends obliquely upward inside the intermediate housing 4 so as to open to a corner part of the upper and side surfaces of the engine 1. Moreover, although not illustrated, another exhaust port opens to the part of the inner surface of the side housing 5 facing the exhaust operation chamber 8, so as to oppose the exhaust port 10. The other exhaust port also extends obliquely upward inside the side housing 5 so as to open to the corner part of the upper and side surfaces of the engine 1. For the engine 1, a so-called side exhaust system is adopted and a position and a shape of an opening of the exhaust port 10 are designed such that an open timing of the intake port does not overlap with that of the exhaust port. Thus, remaining exhaust gas which affects the next stroke is reduced.

Note that the reference numeral 103 in FIG. 4 indicates a secondary air passage for supplying secondary air into an exhaust passage. Moreover, the configuration of the exhaust port 10 is described later in detail.

Thus, with the rotary piston engine 1, as opposed to the conventional rotary piston engine, when the engine 1 is seen along the output shaft X from one side thereof, the intake port 11 is formed in the lower part of the engine 1, and the exhaust port 10 is formed in the upper part of the engine 1.

An injector 81 for supplying the fuel into the operation chamber 8 is attached to the intermediate housing 4, and injects the fuel into the intake port 11 formed in the intermediate housing 4. As illustrated in FIG. 4, the injector 81 is arranged such that an axis thereof inclines obliquely downward, the injector 81 extends to the intake port 11 from the side surface of the intermediate housing 4, and a tip of the injector 81 is oriented toward inside the intake port 11. Thus, the injector 81 injects the fuel into the intake port 11 along a flow direction of the intake air. The injected fuel is introduced into the intake operation chamber 8 through the opening of the intake port 11 while mixing with the intake air flowing inside the intake port 11.

The T-side ignition plug 82 and the L-side ignition plug 83 are attached to a trailing side (retard side) position and a leading side (advance side) position of a side part of the rotor housing 3 in the rotor rotational direction with respect to the short axis Z, respectively. These two ignition plugs 82 and 83 are oriented toward inside the combustion/expansion operation chamber 8 and ignite the mixture gas inside the combustion/expansion operation chamber 8 simultaneously or sequentially with a phase difference therebetween. By providing the two ignition plugs 82 and 83 as above, a combustion speed is increased inside the combustion/expansion operation chamber 8 having a flat shape.

As described above, with the rotary piston engine 1, the intake port 11 is formed in the lower part of the engine 1. An intake manifold 12 communicating with the intake port 11 and forming a part of the intake passage is provided to extend downward from above at a position on one side (left side in this embodiment) of the engine 1.

The intake manifold 12 includes a common passage 121 and first to fourth independent passages 122 communicating with the common passage 121. As illustrated in FIGS. 2 and 3, the common passage 121 is disposed to an upper part on the left side of the engine 1 and corresponds to the upper part of the engine 1. The common passage 121 curves at its intermediate portion and is arranged such that an upstream end portion thereof is oriented forward. The throttle body 123 is attached to the common passage 121 at a position in front of the upper part on the left side of the engine 1. A downstream end portion of the common passage 121 is oriented downward near a center of the upper part on the left side of the engine 1 in the front-and-rear directions (i.e., near the intermediate housing 4).

All four of the independent passages 122 are connected, at upstream end portions thereof, with the downstream end of the common passage 121 and extend downward. The four independent passages 122 are arranged to form a shape symmetric with respect to the vehicle up-and-down direction (see FIG. 2). Thus, the first independent passage 122 is connected with the intake port formed in the front side housing 5, the second independent passage 122 is connected with the intake port 11 formed in the intermediate housing 4 (the intake port 11 opening to the front rotor accommodation chamber 31 to be exact), the third independent passage 122 is connected with the intake port 11 formed in the intermediate housing 4 (the intake port 11 opening to the rear rotor accommodation chamber 31 to be exact), and the fourth independent passage 122 is connected with the intake port formed in the rear side housing 5.

A common flange 124 extending in the vehicle front-and-rear directions is provided to downstream end portions of the four independent passages 122 aligned in the vehicle front-and-rear directions, and the flange 124 is fixed to a lower portion of a side surface of the engine 1 so that the independent passages 122 are connected with the intake ports 11, respectively (also see FIG. 4).

Moreover, with the rotary piston engine 1, the exhaust ports 10 are formed in the upper part of the engine 1. An exhaust manifold 13 communicating with the exhaust port 10 and forming a part of the exhaust passage is attached to the corner part of the upper and side surfaces of the engine 1. The exhaust manifold 13 includes a total of four independent passages 132 connected with the exhaust ports formed in the respective two side housings 5 and the two exhaust ports 10 formed in the intermediate housing 4, respectively, and a manifold passage 131 where the four independent passages 132 communicate with each other. Among the four independent passages 132, the two independent passages 132 communicating with the exhaust ports 10 of the intermediate housing 4 seem integral in external appearance. Also to downstream end portions of the independent passages 132 of the exhaust manifold 13, a common flange 133 extending in the vehicle front-and-rear directions is provided, and the common flange 133 is fixed to the corner part of the upper and side surfaces of the engine 1 so that the independent passages 132 are connected with the exhaust ports 10, respectively (also see FIG. 4).

An exhaust turbocharger 30 including a turbine 32 and a compressor 33 is disposed at a position above the exhaust manifold 13. Thus, the exhaust turbocharger 30 is located above the front part of the engine 1. The turbine 32 of the exhaust turbocharger 30 is placed on an upper surface of the exhaust manifold 13 and, although not illustrated, communicates with the manifold passage 131 of the exhaust manifold 13. Moreover, although not illustrated, a flow-in port of the compressor 33 of the exhaust turbocharger 30 is connected with an air cleaner via the intake passage, and a flow-out port thereof is connected with the throttle body 123 via the intake passage.

The exhaust passage 34 is connected with a flow-out port of the turbine 32 of the exhaust turbocharger 30. The exhaust passage 34 is arranged to extend rearward at a position above the engine 1 and further extend obliquely downward at a relatively rear position of the engine 1 so as to reach inside the floor tunnel 94 through the concave portion 93 of the dash panel 92. A direct catalyst 35 and an underfoot catalyst 36 are provided to intervene in the exhaust passage 34. The direct catalyst 35 is located above the engine 1 and near the rear end part of the engine 1. The underfoot catalyst 36 is disposed within the floor tunnel 94.

In the rotary piston engine 1 of this embodiment, as described above, the intake ports 11 are formed in the lower part of the engine 1, and thus, the intake passage (i.e., the intake manifold 12) extends downward from above at the position on the side of the engine 1. A length of the intake manifold 12, particularly each independent passage 122, is longer than that of the conventional rotary piston engine in which the intake ports are formed in the upper part of the engine. Such a length, as a result, is advantageous in obtaining a dynamic forced-induction effect caused by an inertia effect. In other words, the intake performance is improved with the rotary piston engine 1 of this embodiment. Further, since the intake manifold 12 and the intake passage formed near the engine 1 are not provided with any large-size devices, the configuration of extending the intake manifold 12 downward from above at the position on the side of the engine 1 is advantageous in reducing the size of the rotary piston engine 1.

Moreover, in the rotary piston engine 1 of this embodiment, the exhaust ports 10 are formed in the upper part of the engine 1, and thus, the exhaust manifold 13 and the exhaust passage 34 are both disposed at positions above the engine 1. By this configuration, lengths of the exhaust manifold 13 and the exhaust passage 34 become comparatively short, and thus, a passage resistance is decreased and exhaust performance is improved.

Furthermore, since the exhaust manifold 13 and the exhaust passage 34 are disposed at the positions above the engine 1, the exhaust turbocharger 30 is also disposed at a position above the engine 1. Here, in the conventional rotary piston engine, since the exhaust ports are formed in the lower part of the engine, for example, the exhaust turbocharger is disposed to a lower part on the left side of the engine 1 as surrounded by the dashed line in FIG. 3. In this case, the exhaust turbocharger may interfere with a cross member 95 (i.e., vehicle body member). On the other hand, in this embodiment, since the exhaust turbocharger 30 is disposed at the position above the engine 1, such interference can surely be inhibited. Moreover, by inhibiting the interference between the exhaust turbocharger 30 and the vehicle body member, the mount position of the rotary piston engine 1 can be lowered as much as possible. Thus, the space above the engine 1 can be increased inside the engine room 90 and a sufficient arrangement space of the exhaust manifold 13, the exhaust turbocharger 30, and the exhaust passage 34 can be secured inside the engine room 90. Further, the direct catalyst 35 can also be disposed close to the engine 1 within the space above the engine 1, which is advantageous in promptly activating the catalyst and improving the exhaust emission performance.

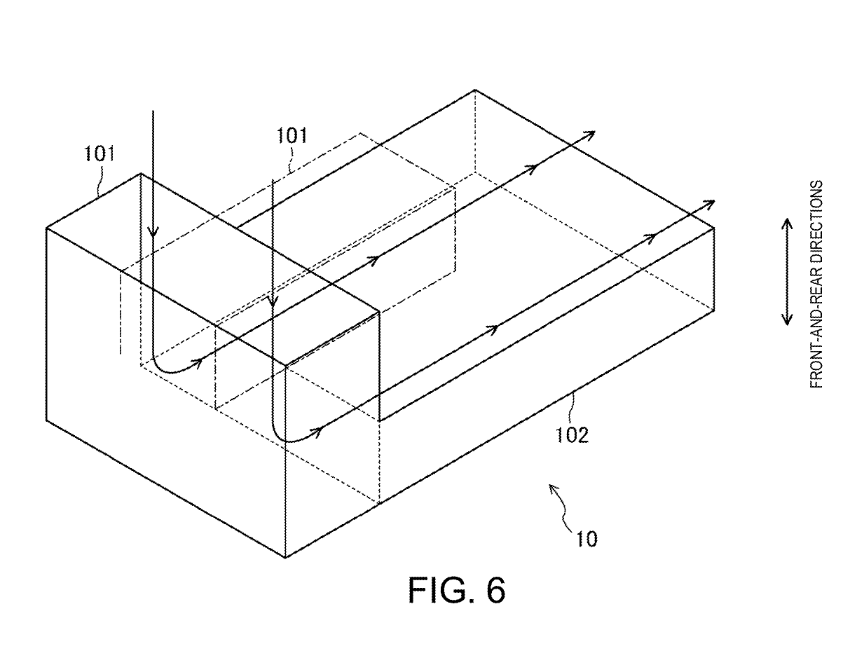

Next, the shape of each exhaust port 10 of the rotary piston engine 1 of this embodiment is described in detail. As illustrated in FIGS. 4 to 6, in the side surface of the side housing (note that the definition of the “side housing” used here includes the intermediate housing 4 and the side housings 5), the exhaust port 10 includes an opening 101 opening to the operation chamber 8, and a passage portion 102 extending to curve continuously from the opening 101, extending inside the side housings 4 and 5 toward an outer circumferential surface of the engine 1, and opening to the outer circumferential surface. FIG. 6 is a conceptual view illustrating a shape of the exhaust port 10, in which the opening 101 extends in the vehicle front-and-rear directions, whereas the passage portion 102 extends perpendicular to the vehicle front-and-rear directions. As indicated by the arrow in FIG. 6, the exhaust gas flows while curving at the interception position between the opening 101 and the passage portion 102. Note that in FIG. 6, the opening 101 is formed into a square shape instead of a substantially elongated triangle shape as described later, for easier understanding.

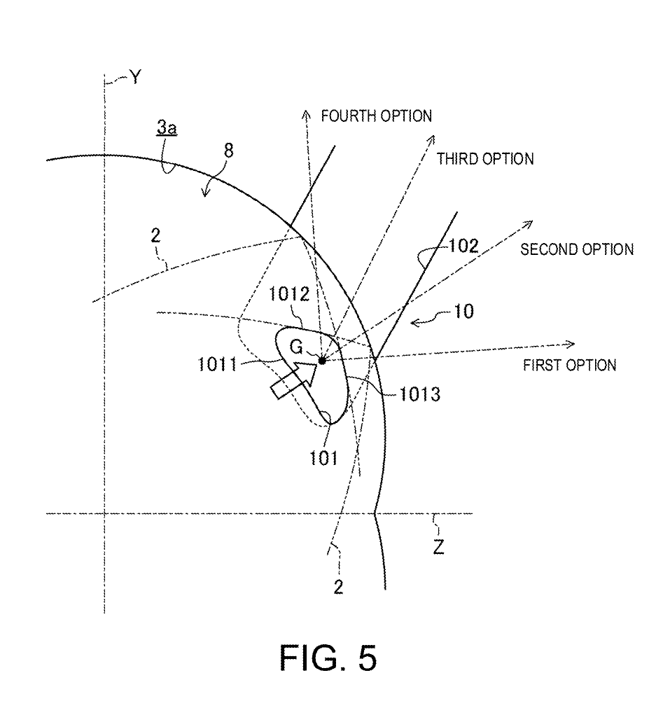

As illustrated in FIG. 5, the opening 101 of the exhaust port 10 has a substantially elongated triangle shape formed by first to third sides 1011 to 1013. Note that the white arrow indicates the flow of the exhaust gas flowing into the opening 101. Among the first to third sides 1011 to 1013, the length of the first side 1011 located on the inner side (closer to the rotational axis X) inside the operation chamber 8 is longer than those of the second and third sides 1012 and 1013 located on the outer side. The shape of the opening 101 having the substantially elongated triangle shape is determined as follows. That is, as virtually illustrated in FIG. 5, the shape of an opening edge corresponding to the second side 1012 is designed to substantially match with the shape of a circumferential edge of the rotor 2 so that the rotor 2, while rotating, opens the exhaust port 10 at a predetermined timing, and the shape of an opening edge corresponding to the third side 1013 is designed to substantially match with a circumferential edge shape of the rotor 2 so that the rotor 2 while rotating closes the exhaust port 10 at a predetermined timing. The shape of an opening edge corresponding to the first side 1011 is designed based on a trail of the oil seal 21 provided to the rotor 2 (see FIG. 4).

While the shape of the substantially-elongated-triangle opening 101 is designed as above, the passage portion 102 is formed to extend in a direction from substantially the center of the first side 1011 of the opening 101 toward a center of gravity G of the triangle as illustrated in FIG. 5. Thus, the passage resistance of the exhaust port 10 can be decreased and the exhaust performance can further be improved.

A description will be given regarding this matter. The one-dotted chain arrows in FIG. 5 indicate options of the extending direction of the passage portion 102 of the exhaust port 10. The options include a first option in which the passage portion 102 is oriented toward the side surface of the engine 1, a second option which forms an angle of 30° with the first option and the passage portion 102 is oriented toward the corner part of the upper and side surfaces of the rotary piston engine 1 (oriented toward a position of the side surface close to the corner), a third option which forms an angle of 60° with the first option and the passage portion 102 is oriented toward the corner part of the upper and side surfaces of the rotary piston engine 1 (oriented toward a position of the upper surface close to the corner), and a fourth option which forms an angle of 90° with the first option and the passage portion 102 is oriented toward the upper surface of the rotary piston engine 1. Among the options, the first option is the closest configuration to the exhaust port of the conventional engine in which the exhaust ports are formed in the lower part of the rotary piston engine. In the conventional engine in which the exhaust ports are formed in the lower part of the rotary piston engine, the passage portion of the exhaust port is generally opened to the lower portion of the side surface of the engine by extending the passage portion substantially horizontally toward the side surface of the engine, so that the exhaust manifold is attached to the lower portion of the side surface of the engine.

Among the options in FIG. 5, with both of the second and third options, the passage portion 102 extends in the direction from substantially the center of the first side 1011 of the opening 101 toward the center of gravity G of the triangle. Specifically, an angle between the direction from substantially the center of the first side 1011 of the opening 101 toward the center of gravity G of the triangle and the extending direction of the passage portion 102 is small. On the other hand, with the fourth option, the angle between the direction from substantially the center of the first side 1011 of the opening 101 toward the center of gravity G of the triangle and the extending direction of the passage portion 102 is large. Moreover, also with the first option, the angle between the direction from substantially the center of the first side 1011 of the opening 101 toward the center of gravity G of the triangle and the extending direction of the passage portion 102 is relatively large. When the angle becomes large, the opening 101 with the passage portion 102 has a positional relationship as indicated by the one-dotted chain line in FIG. 6. Specifically, as the angle becomes larger, a flow path width of the opening 101 becomes narrower with respect to a flow path width of the passage portion 102, and when the exhaust gas flows into the passage portion 102 from the opening 101, turbulence of the exhaust gas flow becomes greater, and a flow path resistance is increased. On the other hand, when the angle becomes small, the opening 101 with the passage portion 102 has a positional relationship as indicated by the solid line in FIG. 6. Specifically, as the angle becomes smaller, the difference between the flow path width of the opening 101 and the flow path width of the passage portion 102 becomes smaller, and as indicated by the arrows in FIG. 6, when the exhaust gas flows into the passage portion 102 from the opening 101, the turbulence of the exhaust gas flow is small, and the exhaust gas flows smoothly. As a result, the increase of the flow path resistance can be inhibited.

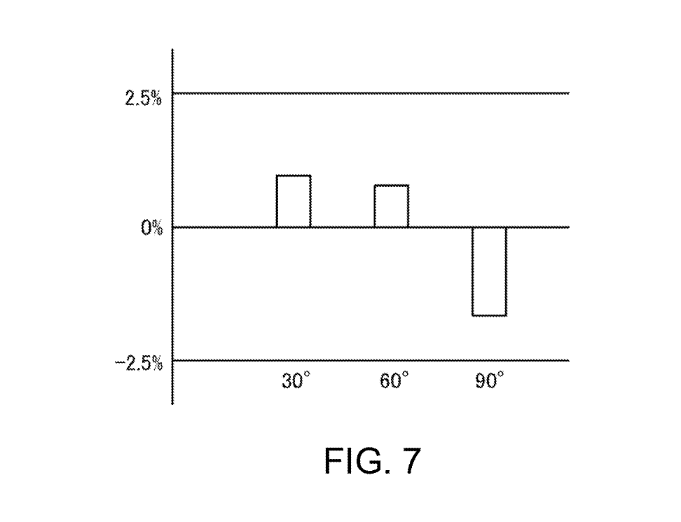

FIG. 7 is a view illustrating change rates of a mass flow rate in the second to fourth options with respect to the first option, respectively. Note that as the mass flow rate is increased, the flow path resistance of the exhaust gas passing through the exhaust port 10 becomes smaller, and whereas as the mass flow rate is reduced, the flow path resistance of the exhaust gas passing through the exhaust port 10 becomes larger. According to FIG. 7, with the second option (30°) and the third option (60°), the mass flow rate is increased compared to the first option. With the second and third options, the passage resistance can be reduced compared to the first option, in other words, the exhaust port of the conventional structure. On the other hand, with the fourth option (90°), the mass flow rate is reduced compared to the first option. With the fourth option, the passage resistance becomes larger than the first option. Therefore, in reducing the passage resistance of the exhaust passage, either one of the second and third options is preferably adopted for the shape of the exhaust port 10. Note that the rotary piston engine 1 in FIGS. 1 to 5 corresponds to the third option.

Since the orientation of the passage portion 102 is designed to reduce the passage resistance, as illustrated in FIG. 4, the passage portion 102 opens to the corner part of the upper and side surfaces of the rotary piston engine 1, which improves connectivity between the exhaust turbocharger 30 and the exhaust passage 34 disposed above the engine 1.

Note that in this embodiment, the twin-rotor engine having two rotors 2 is described as an example; however, the number of the rotors 2 (number of cylinders) is not limited to this.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

1 Rotary Piston Engine (Rotary Piston Engine Body)
10 Exhaust Port
101 Opening
102 Passage Portion
11 Intake Port
12 Intake Manifold (Intake Passage)
13 Exhaust Manifold (Exhaust Passage)
2 Rotor
21 Oil Seal
3 Rotor Housing
31 Rotor Accommodation Chamber
34 Exhaust Passage
4 Intermediate Housing (Side Housing)
5 Side Housing
X Output Shaft

What is claimed is:

1. A rotary piston engine mounted on a vehicle, comprising:
a rotary piston engine body mounted on the vehicle in an orientation where an output shaft of the rotary piston engine body extends substantially horizontally;
an intake passage connected with an intake port formed in the rotary piston engine body; and
an exhaust passage connected with an exhaust port formed in the rotary piston engine body,
wherein when the rotary piston engine is seen along the output shaft, the intake port is formed in a lower part of the rotary piston engine body and the exhaust port is formed in an upper part of the rotary piston engine body, and
wherein the intake passage is disposed on one side of the rotary piston engine body and the exhaust passage is disposed above the rotary piston engine body.

2. The engine of claim 1, wherein the rotary piston engine body includes:
a triangle rotor which rotates in a planetary fashion;
a rotor housing having a trochoid inner circumferential surface with which the rotor slidably contacts; and
a side housing disposed on one side of the rotor housing and for defining, together with the rotor housing, a rotor accommodation chamber for accommodating the rotor therein,
wherein the exhaust port includes:
an opening formed in the side housing to open to the rotor accommodation chamber, and having a predetermined substantially elongated triangle shape of which one side corresponds to an edge of the opening designed based on a trail of an oil seal provided to the rotor; and
a passage portion extending to curve continuously from the opening, extending inside the side housing toward an outer circumferential surface of the rotary piston engine body, and opening to the outer circumferential surface, and
wherein the passage portion extends toward a center of gravity of the predetermined substantially elongated triangle from the edge of the opening.

3. The engine of claim 1, wherein an exhaust turbocharger is disposed in the exhaust passage, and
wherein the exhaust turbocharger is located above the rotary piston engine body.

4. The engine of claim 2, wherein an exhaust turbocharger is disposed in the exhaust passage, and
wherein the exhaust turbocharger is located above the rotary piston engine body.
